(19) United States
(12) Patent Application Publication
(10) Pub. No.: US 2003/0120046 A1
(43) Pub. Date: Jun. 26, 2003

(54) Radioisotope-labeled complexes of glucose derivatives and kits for the preparation thereof

(76) Inventors: Hee-Kyung Lee, Seoul (KR); Dae-Hyuk Moon, Seoul (KR); Jin-Sook Ryu, Seoul (KR); Jae-Seung Kim, Seoul (KR); Seung-Jun Oh, Seoul (KR)

Correspondence Address: EDWARDS & ANGELL, LLP, P.O. BOX 9169, BOSTON, MA, 02209, US

(21) Appl. No.: 10/239,374

(22) PCT Filed: Feb. 1, 2001
(86) PCT No.: PCT/KR01/00140

(30) Foreign Application Priority Data
Mar. 21, 2000 (KR) 2000-14214

(51) Int. Cl. C07F 5/00; C07F 13/00

(52) U.S. Cl. 534/11; 534/14

(57) ABSTRACT

The present invention relates to a complex comprising one or more radioisotopes selected from the group consisting of ^{99m}Tc, ¹⁸⁸Re and ¹⁸⁶Re chelated to a glucose derivative having an intramolecular nitrogen or sulfur atom, which is very useful as tumor diagnostic agents. It also relates to a kit for the preparation thereof comprising the glucose derivative and a reducing agent.

### TECHNICAL FIELD

The present invention relates to a radioisotope-labeled complex of glucose derivatives useful as tumor imaging agents. More specifically, the present invention relates to a complex comprising a radioisotope chelated to a glucose derivative having an intramolecular nitrogen or sulfur atom and a kit for the preparation thereof comprising the glucose derivatives and a reducing agent.

### BACKGROUND ART

It is known that as compared with normal cells, tumor cells display hyperactive glucose metabolism, and have the increased number of glucose carriers and thereby, display the increased uptake of glucose. Therefore, in case that radiopharmaceuticals comprising glucose labeled with a radioisotope are administered to a living body, the radioisotope-labeled glucose will be absorbed into tumor cells in a larger amount than into normal cells and thereby, a radioactivity detected in tumor will be higher than that detected in normal tissues.

A radiopharmaceutical [¹⁸F]FDG (fluorodeoxyglucose) is known as a glucose derivative useful for reflection of changes in glucose metabolism of tumor, and early diagnosis, staging and recurrence decision of various tumors. However, it requires special equipment such as cyclotron for the preparation thereof because of its short half-life (110 minutes) and further, requires PET (Positron Emission Tomography) scanner amounting to 5 million dollars for setting the facility and producing image. Diagnostic agents of this kind which can be imaged by gamma camera, relatively inexpensive compared with PET camera (3 to 4 hundred thousands dollars), have never been developed yet.

The known radiopharmaceuticals for diagnosing tumor generally include radioisotopes which are not widely available, e.g. gallium-67 (⁶⁷Ga), indium-111 (¹¹¹In), fluorine-18 (¹⁸F) and the like. In contrast, technetium-99m (^{99m}Tc) which is most widely used in nuclear medicine at the present time and which can be easily prepared using a generator emits gamma-radiation of 141 keV most suitable for obtaining image in nuclear medicine, has a half-life of 6 hours and is relatively inexpensive. In addition, radioisotopes similar to ^{99m}Tc, rhenium-186 (¹⁸⁶Re) and rhenium-188 (¹⁸⁸Re) emit gamma-radiation of 137 keV and 155 keV, respectively and have a half-life of 88.9 hours and 16.7 hours, respectively. However, there exist still many problems in preparing radiopharmaceuticals using the above-mentioned technetium and rhenium because of their chemical properties. For example, it is conventional that radiopharmaceuticals can be prepared using ^{99m}Tc only via a coordinate bond thereof with a particular ligand. By contrast, radiopharmaceuticals can be prepared using other radioisotopes such as ¹²³I and ¹⁸F by an oxidation-reduction or nucleophilic substitution reaction with a ligand. Therefore, it is much more difficult to prepare radiopharmaceuticals from ^{99m}Tc than from other radioisotopes. Especially, since glucose has only oxygen and carbon atoms within a molecule, it would be difficult to form a stable coordinate bond with ^{99m}Tc.

^{99m}Tc-MIBI (methoxy isobutyl isonitrile) has been developed as a technetium-99m labeled radiopharmaceutical for diagnosis of tumor in nuclear medicine. However, it has not only unsatisfactory uptake rate in tumor but also a low efficiency in diagnosing the abdominal tumor because of its high uptake rate in the abdomen (Kaku Igaku, Vol. 34 (10), page 939 (1997)). Moreover, image of ^{99m}Tc-MIBI can be obtained only between 10 and 15 minutes after injection due to its high wash-out rate in vivo, and cannot be obtained after 4 to 5 hours with a low background radioactivity.

### DISCLOSURE OF THE INVENTION

The present inventors have extensively studied to develop a novel radiopharmaceutical which can solve the above-described problems. As a result, they have discovered that glucose derivatives having a nitrogen or sulfur atom within a molecule can be labeled with ^{99m}Tc, ¹⁸⁸Re, ¹⁸⁶Re, etc., which is inexpensive and can be conveniently used. In addition, they revealed that complexes of the glucose derivatives labeled with such radioisotopes enable imaging of tumor using gamma camera, relatively inexpensive compared with PET camera. They also found out that the complexes can be prepared at a low cost and are excellent radiopharmaceuticals having a high uptake rate in tumor and thus, completed the present invention.

Therefore, it is an object of the present invention to provide a complex comprising a radioisotope such as ^{99m}Tc, ¹⁸⁸Re or ¹⁸⁶Re chelated to a glucose derivative having an intramolecular nitrogen or sulfur atom. It is another object of the present invention to provide a kit for the preparation thereof.

One aspect of the present invention relates to a complex comprising a radioisotope selected from the group consisting of ^{99m}Tc, ¹⁸⁸Re and ¹⁸⁶Re chelated to a glucose derivative having an intramolecular nitrogen or sulfur atom.

Another aspect of the present invention relates to a kit for the preparation of a radiopharmaceutical comprising a glucose derivative having an intramolecular nitrogen or sulfur atom and a reducing agent.

Hereinafter, the present invention will be specifically explained.

Radioisotopes which can be employed in the present invention include radioisotopes of 7B group, e.g. ^{99m}Tc, ¹⁸⁸Re, ¹⁸⁶Re and the like, and ^{99m}Tc is preferably employed. In particular, ^{99m}Tc in the +5 oxidation state can form a coordinate bond with an atom acting as an electron donor, e.g. a nitrogen or sulfur atom. Therefore, glucose having only oxygen and carbon atoms, which is difficult to form a coordinate bond with a metal, is difficult to form a stable coordinate bond with ^{99m}Tc. By contrast, a glucose derivative having an intramolecular nitrogen or sulfur atom can form a stable coordinate bond with ^{99m}Tc. Since ^{99m}Tc obtained from a generator has the +7 oxidation state, it must be reduced to the +5 oxidation state using a reducing agent such as stannous chloride (II) and then, can form a coordinate bond with a glucose derivative having a nitrogen or sulfur atom within a molecule. Radioisotopes such as ¹⁸⁸Re and ¹⁸⁶Re can also be labeled according to the above-mentioned procedure.

As a glucose derivative which can be labeled with a radioisotope such as ^{99m}Tc, etc. and which retains biochemical properties of glucose, a glucose derivative having a nitrogen or sulfur atom within a molecule can be employed. Preferably, 1-thio-D-glucose, 5-thio-D-glucose, glucosamine, or salts or hydrates thereof, more particularly, sodium 1-thio-β-D-glucose dihydrate of the following formula (1):

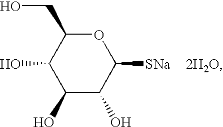

5-thio-D-glucose α-anomer of the following formula (2):

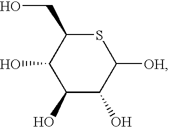

or D-glucosamine of the following formula (3):

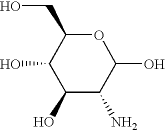

Specific processes for preparing ^{99m}Tc-labeled complexes of glucose derivatives are described in the following examples 1 to 3, and according to the above processes, the complexes were obtained in a high purity of 98% or more as a result of measurement of the labeling efficiency of each complex. Further, ^{99m}Tc-labeled radiopharmaceuticals were tested for their stability in a physiological saline and the human plasma with the lapse of time (see Example 4). As a result, the radiopharmaceuticals of the present invention were shown to be very stable. The radiopharmaceuticals of the present invention were tested for biodistribution and the uptake level in rabbits transplanted with VX-2 tumor cells and then, compared with ^{99m}Tc-MIBI currently used for imaging tumor in nuclear medicine (see Example 5). More specifically, ^{99m}Tc-labeled glucose derivatives were injected to rabbits transplanted with tumor cells to obtain image using gamma camera. Then, the organs were removed to measure biodistribution and the uptake level of radiopharmaceuticals by calculating % ID (injected dose)/g, indicative of the uptake level of the injected radiopharmaceuticals per weight of tissues. As a result, the radiopharmaceuticals comprising the glucose derivatives according to the present invention could be quite conveniently applied in producing image using gamma camera. In particular, among three ^{99m}Tc-labeled glucose derivatives, ^{99m}Tc-1-thio-D-glucose and ^{99m}Tc-5-thio-D-glucose displayed 4 to 6-fold and 2 to 3-fold uptake rate in tumor compared with in normal region, respectively. By contrast, ^{99m}Tc-MIBI widely used for tumor detection in nuclear medicine displayed only 1 to 2-fold uptake rate in tumor compared with in normal region. Therefore, it confirms that ^{99m}Tc-labeled glucose derivatives displayed 2 to 3-fold uptake rate in tumor compared with ^{99m}Tc-MIBI. Detailed results are set forth in the following examples.

As mentioned above, ^{99m}Tc-labeled complexes of glucose derivatives in accordance with the present invention displaying a high selective uptake in tumor cells are very useful as radiopharmaceuticals.

In order to image mammalian tumor, complexes prepared according to the present invention in a physiological saline or injectable water may be intravenously injected to a mammal and then, the mammal be exposed to a gamma camera or any other suitable equipment to produce image.

The present invention also provides a kit for the preparation of the above radioisotope-labeled complex. This kit comprises a glucose derivative having an intramolecular nitrogen or sulfur atom and a reducing agent. The present radioisotope-labeled complex is preferably prepared by adding a radioisotope to the kit immediately before its use, considering a half-life of the radioisotope and emission of radiation. For the preparation of a radiopharmaceutical, a radioisotope, a reducing agent to form a bond between the radioisotope with a particular ligand, and an additive to increase the stability of the resulting radiopharmaceutical are used together. But, practically, the radioisotope is impossible to supply in exposure to the public because it emits radiation. Accordingly, all the compounds except the radioisotope are introduced together into a vial, and sterilized, frozen and/or dried to manufacture a kit. Then, the radioisotope is preferably added to the kit immediately before its use to obtain the radiopharmaceutical.

The kit according to the present invention contains each compound in an amount sufficient to image mammalian tumor. Preferably, it contains a glucose derivative and a reducing agent in an amount sufficient to prepare about 0.2 to about 0.3 mCi of ^{99m}Tc, ¹⁸⁸Re or ¹⁸⁶Re-labeled complex per 1 kg of the mammal to be imaged. The reducing agent employable in the present invention includes stannous compounds, e.g. stannous chloride (II), formamidine sulfinic acid, sulfuric acid or sodium borohydride, etc. An additive such as a stabilizing agent, e.g. ascorbic acid, sodium bisulfite or sodium pyrosulfite, etc. is optionally added to enhance the stability of the resulting radiopharmaceutical. The specific process for manufacturing the kit of the present invention is exemplified in the following Example 6.

### BRIEF DESCRIPTION OF THE DRAWINGS

FIG. 1 shows the images at 1 and 3 hrs after injection of ^{99m}Tc-1-thio-D-glucose to rabbits transplanted with VX-2 tumor cells.

### BEST MODE FOR CARRYING OUT THIE INVENTION

This invention will be better understood from the following examples. However, one skilled in the art will readily appreciate the specific materials and results described are merely illustrative of, and are not intended to, nor should be intended to, limit the invention as described more fully in the claims, which follow thereafter.

### EXAMPLE 1

### Preparation of ^{99m}Tc-1-thio-D-glucose

20 mCi/ml of ^{99m}TcO₄⁻ was added to 1-thio-β-D-glucose (1 mg, 0.46 mmol) and SnCl₂.2H₂O (80 μg) in a 10 ml vial. After stirring for 10 minutes, the labeling efficiency was measured by thin layer chromatography (TLC). The labeling efficiency was expressed as the radiochemical purity and the radiochemical purity was measured as follows.

5 μl of 99mTc-1-thio-D-glucose was added dropwise at a distance of 1 cm from the bottom of TLC (7 mm×7 cm) and then, developed using acetone (or methyl ethyl ketone) and a physiological saline, respectively. The ratio of the residual technetium peroxide-^{99m} (^{99m}TcO₄⁻) was calculated by measurement of radioactivity in the upper part of TLC developed with acetone, and the ratio of ^{99m}TcO₂ was calculated by measurement of radioactivity in the lower part of TLC developed with the physiological saline. The radiochemical purity of ^{99m}Tc-1-thio-D-glucose equals to the ratio of the radioactivity obtained by subtracting the ratio of the above two parts from 100%. That is, the purity is obtained from the following formula:

100%−[(radioactivity in the upper part of TLC developed with acetone÷radioactivity in the whole TLC developed with acetone)+(radioactivity in the lower part of TLC developed with 0.9% physiological saline÷radioactivity in the whole TLC developed with 0.9% physiological saline)]×100%

After measurement of the labeling efficiency, ^{99m}Tc-1-thio-D-glucose was sterile filtered through 0.22 μm microfilter and then, collected in an aseptic vial. As a result of 10 experiments, 99% or more of the labeling efficiency was obtained.

### EXAMPLE 2

### Preparation of 99mTc-5-thio-D-glucose

^{99m}Tc-5-thio-D-glucose was prepared using 5-thio-D-glucose (5 mg, 0.51 mmol) as a precursor according to the procedure of Example 1, and the labeling efficiency was measured in the same manner as Example 1. As a result of 10 experiments, 99% or more of the labeling efficiency was obtained.

### EXAMPLE 3

### Preparation of ^{99m}Tc-glucosamine

^{99m}Tc-glucosamine was prepared using glucosamine (5 mg, 2.32 mmol) as a precursor according to the procedure of Example 1, and the labeling efficiency was measured in the same manner as Example 1. As a result of 10 experiments, 99% or more of the labeling efficiency was obtained.

### EXAMPLE 4

### Stability Test of Radiopharmaceuticals

The stability of radiopharmaceuticals was expressed as the purity of radiopharmaceutical at a given time, and measured after 0, 2, 4 and 6 hrs in a physiological saline and the human plasma, respectively. First, two vials were prepared and then, 5 mCi/0.5 ml of ^{99m}Tc-1-thio-D-glucose was introduced into one vial and diluted to give a solution having the total volume of 2 ml by adding 1.5 ml of the physiological saline. 5 mCi/0.5 ml of ^{99m}Tc-1-thio-D-glucose was introduced into another vial, and 0.5 ml of physiological saline and 0.2 ml of the human plasma were added together thereto. After well stirring the ingredients in each vial, the stability was measured at given times at room temperature.

The stability was measured as follows. 5 μl of each radiopharmaceutical was deposited in the lower part of TLC and was developed using methyl ethyl ketone (or acetone) and 0.9% physiological saline, respectively. Upon completion of development, each TLC was equally divided into 2 parts and the radioactivity of each part was measured using gamma counter. The stability was calculated by measurement of the purity from the obtained radioactivity. Among 2 parts of TLC developed with methyl ethyl ketone, the upper part displays the radioactivity of free ^{99m}Tc (i.e. the residual ^{99m}Tc) and the lower part displays the radioactivity of ^{99m}Tc-labeled 1-thio-D-glucose. Among 2 parts of TLC developed with 0.9% physiological saline, the upper part displays the radioactivity of ^{99m}Tc-1-thio-D-glucose and the lower part displays the radioactivity of free ^{99m}Tc (i.e. ^{99m}TcO₂). The purity of radiopharmaceuticals is calculated as follows. For example, the purity of ^{99m}Tc-1-thio-D-glucose is obtained from the following formula:

100%−[(radioactivity in the upper part of TLC developed with acetone÷radioactivity in the whole TLC developed with acetone)+(radioactivity in the lower part of TLC developed with 0.9% physiological saline÷radioactivity in the whole TLC developed with 0.9% physiological saline)]×100%

These data are irrelevant to a half-life of radioisotope. The mean purity obtained from 3 experiments according to the above procedure, i.e. the stability of radiopharmaceuticals at given times is set forth in the following Table 1.

TABLE 1
Stability of ^{99m}Tc-labeled glucose derivatives

| | Purity of radiopharmaceuticals at given times (%) | | | | | | | |
|---|---|---|---|---|---|---|---|---|
| Radiopharma- | In a physiological saline | | | | In the human plasma | | | |
| ceuticals | 0 h | 2 h | 4 h | 6 h | 0 h | 2 h | 4 h | 6 h |
| ^{99m}Tc-1-thio- | 99.5 | 99.6 | 98.6 | 98.1 | 99.5 | 98.0 | 95.4 | 92.0 |
| D-glucose | | | | | | | | |
| ^{99m}Tc-5-thio- | 99.8 | 98.7 | 98.2 | 98.0 | 99.8 | 98.2 | 95.1 | 90.0 |
| D-glucose | | | | | | | | |
| ^{99m}Tc-glu- | 99.5 | 98.9 | 98.0 | 97.6 | 99.5 | 95.4 | 95.0 | 92.4 |
| cosamine | | | | | | | | |

### EXAMPLE 5

### Imaging and Determination of Biodistribution of ^{99m}Tc-Labeled Glucose Derivatives

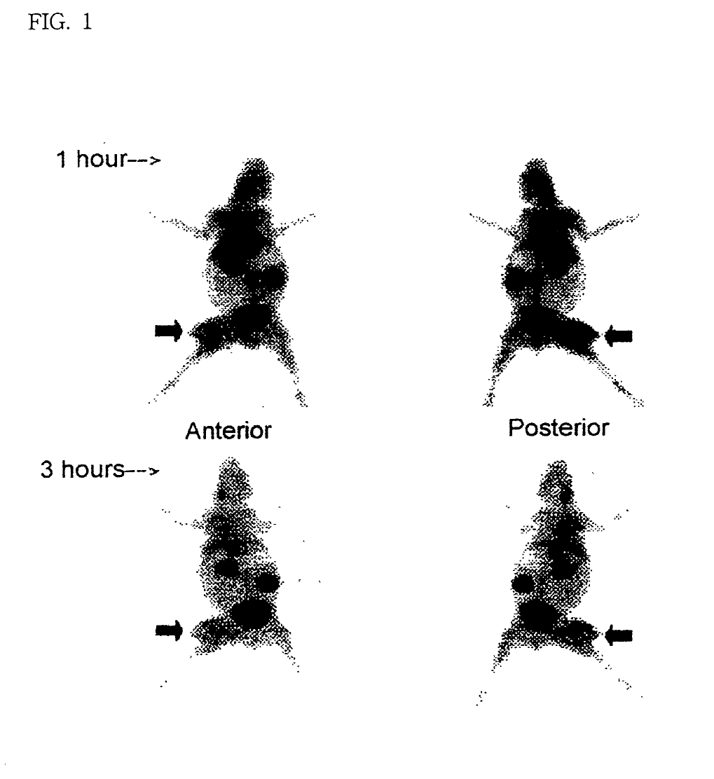

VX-2 tumor cells were ground in 2 ml of a physiological saline and then, transplanted via intramuscular injection to the right thigh muscle of three rabbits (New Zealand White species) weighing 2.5 to 3 kg using a syringe. Then, the rabbits were bred for 3 weeks to grow tumor to have a diameter of 2 to 3 cm. The rabbits were anesthetized with ketamine and silazine and 1.5 mCi of ^{99m}Tc-1-thio-D-glucose, ^{99m}Tc-5-thio-D-glucose and ^{99m}Tc-MIBI were injected to the pinnal vein of rabbits, respectively. After injection, the rabbits were laid down under gamma camera and the gamma camera was controlled to cover the whole body and images were obtained for 15 minutes at 1 and 3 hours after injection, respectively. FIG. 1 shows the images at 1 and 3 hours after injection of ^{99m}Tc-1-thio-D-glucose. It can be seen from FIG. 1 that arrows indicate the regions to which the tumor cells were transplanted and that a large amount of ^{99m}Tc-1-thio-D-glucose was absorbed into tumor.

The image of ^{99m}Tc-MIBI was obtained at 10 minutes after injection. This is because 99Tc-MIBI is rapidly washed out in vivo and thus, image cannot be practically obtained at 30 minutes or more after injection and the best image can be obtained between 10 and 15 minutes after injection. It is conventional that the standardized imaging time cannot be applied for radiopharmaceuticals since their physical, chemical and physiological properties all are different. Thus, the optimal imaging time may be set depending upon the employed radiopharmaceutical.

The regions of interest were established in tumor and normal region of the opposite inguinal region of rabbits injected with ^{99m}Tc-1-thio-D-glucose and ^{99m}Tc-MIBI, respectively. After obtaining image of the regions of interest, the uptake level of radioactivity was calculated from counts (unit of radioactivity) obtained by a particular program equipped with a gamma camera. The results are shown in the following Table 2.

TABLE 2
Comparison of counts between tumor and normal region

| | | 1 hour | | | 3 hours | | |
|---|---|---|---|---|---|---|---|
| | | | | Tumor/ | | | Tumor/ |
| | | | | Normal | | | Normal |
| | | Tumor | Normal | ratio | Tumor | Normal | ratio |
| ^{99m}Tc-1-thio-D-glc | anterior | 7133 | 1762 | 4.0 | 5499 | 888 | 6.2 |
| | posterior | 8876 | 2142 | 4.1 | 7194 | 1172 | 6.1 |
| ^{99m}Tc-5-thio-D-glc | anterior | 1208 | 600 | 2.0 | 1037 | 478 | 2.2 |
| | posterior | 1538 | 613 | 2.5 | 1283 | 436 | 2.9 |
| ^{99m}Tc-MIBI* | anterior | 9931 | 5829 | 1.7 | | | |
| | posterior | 13047 | 6566 | 2.0 | | | |

*Data obtained at 10 minutes after injection

In addition, the tumor uptake rate/normal region uptake rate ratios (anterior image) obtained from 3 experiments are shown in the following Table 3.

TABLE 3
Comparison of uptake of ^{99m}Tc-1-thio-D-glucose, ^{99m}Tc-5-thio-D-glucose
and ^{99m}Tc-MIBI in rabbits (Mean ± S.D. from 3 experiments)

| | Tumor uptake/normal region uptake ratio | |
|---|---|---|
| Radiopharmaceutical | 1 hour | 3 hours |
| ^{99m}Tc-1-thio-D-glucose | 3.32 ± 0.79 | 3.82 ± 1.24 |
| ^{99m}Tc-5-thio-D-glucose | 2.55 ± 0.71 | 3.12 ± 0.67 |
| ^{99m}Tc-MIBI* | 2.22 ± 0.87 | |

*Data obtained at 10 minutes after injection

As shown in the above Tables, ^{99m}Tc-1-thio-D-glucose displayed 4 to 6-fold uptake in tumor compared with in normal region, and ^{99m}Tc-5-thio-D-glucose displayed 2 to 3-fold uptake in tumor compared with in normal region. ^{99m}Tc-MMBI widely used for tumor diagnosis in nuclear medicine displayed only 1 to 2-fold uptake in tumor compared with in normal region. That is, ^{99m}Tc-labeled glucose derivatives displayed 2 to 3-fold uptake compared with the known ^{99m}Tc-MIBI.

The rabbits injected with ^{99m}Tc-1-thio-D-glucose were imaged at 3 hours after injection and then, sacrificed. The organs, i.e. tumor (the right thigh muscle), normal left thigh muscle, liver, spleen, lung, kidney, stomach, small intestine, bone, heart and blood were removed, weighed and counted on gamma counter to obtain % ID/g. The results are shown in the following Table 4.

TABLE 4
Biodistribution of ^{99m}Tc-1-thio-D-glucose at 3 hours after injection
(Mean ± S.D. from 3 experiments)

| Measured regions | Uptake rate of radiopharmaceutical (% ID/g) |
|---|---|
| Tumor (right thigh muscle) | 0.165 ± 0.048 |
| Normal (left thigh muscle) | 0.026 ± 0.018 |
| Liver | 0.330 ± 0.138 |
| Spleen | 0.145 ± 0.065 |
| Lung | 0.182 ± 0.072 |
| Kidney | 6.225 ± 1.619 |
| Stomach | 0.109 ± 0.051 |
| Small intestine | 0.125 ± 0.039 |
| Bone | 0.019 ± 0.015 |
| Heart | 0.120 ± 0.038 |
| Blood | 0.099 ± 0.035 |

It can be seen that the abdomen uptake of ^{99m}Tc-1-thio-D-glucose was negligible, while ^{99m}Tc-MIBI displayed significant abdomen uptake.

### EXAMPLE 6

### Manufacture and Application of a Kit

1 mg of 1-thio-β-D-glucose, 80 μg of stannous chloride (II) dissolved in 100 μl of 0.02 N HCl and 0.5 mg of ascorbic acid as an additive were dissolved together in 1 ml of a physiological saline. Then, the resulting solution was passed through a sterile filter (pore size 0.22 μm) and then, filled in a 10 ml vial. The ingredients of the vial were frozen under liquid nitrogen and dehydrated in a freeze-dryer. Upon completion of dehydration, the vial was sealed with an aluminum cap under vacuum and kept at room temperature. 50 mCi/1.5 ml of ^{99m}Tc dissolved in the physiological saline was added to the vial and the vial was stirred at room temperature for 10 minutes before the use.

### INDUSTRIAL APPLICABILITY

Complexes comprising a radioisotope such as ^{99m}Tc, ¹⁸⁸Re or ¹⁸⁶Re chelated to a glucose derivative having an intramolecular nitrogen or sulfur atom in accordance with the present invention can be used in tumor imaging by using gamma camera, which is relatively inexpensive compared with PET camera. The complexes are useful radiopharmaceuticals with a high uptake rate in tumor. In particular, since the complexes display a low abdomen uptake, they are advantageous over ^{99m}Tc-MIBI having a low efficiency in diagnosing the abdominal tumor because of its high abdomen uptake Further, imaging of changes in biochemical metabolism of tumor will contribute in accurate diagnosis and efficient therapy of tumor in addition to the prior radiological anatomical imaging method.

1. A complex comprising one or more radioisotopes selected from the group consisting of ^{99m}Tc, ¹⁸⁸Re and ¹⁸⁶Re chelated to a glucose derivative having an intramolecular nitrogen or sulfur atom.

2. The complex according to claim 1, wherein said glucose derivative is selected from the group consisting of 1-thio-D-glucose, glucosamine, and salts and hydrates thereof.

3. A kit for the preparation of a radiopharmaceutical comprising a glucose derivative having an intramolecular nitrogen or sulfur atom and a reducing agent.

4. The kit according to claim 3, wherein said reducing agent is one or more selected from the group consisting of stannous chloride (II), formamidine sulfinic acid, sulfuric acid and sodium borohydride.

5. The kit according to claim 3 or 4, which further comprises an additive.

6. The kit according to claim 5, wherein said additive is one or more selected from the group consisting of ascorbic acid, sodium bisulfite and sodium pyrosulfite.
